(19) United States
(12) Patent Application Publication
(10) Pub. No.: US 2025/0162851 A1
(43) Pub. Date: May 22, 2025

(54) Storage Tote Lifting Device

(71) Applicant: David W. McCotter, Beaverton, OR (US)

(72) Inventor: David W. McCotter, Beaverton, OR (US)

(21) Appl. No.: 18/529,800

(22) Filed: Dec. 5, 2023

Related U.S. Application Data
(63) Continuation-in-part of application No. 29/917,666, filed on Nov. 21, 2023.

(51) Int. Cl. B66F 15/00

(52) U.S. Cl. CPC B66F 15/00

(57) ABSTRACT

The storage tote lifting device is used to safely, efficiently, and effectively raise totes, boxes, or other cargo overhead for storage while using a ladder. It is compatible for use with any standard sized ladder. Using a plurality of different lifting handles, the storage tote lifting device can attach to different shapes and sizes of totes, boxes, or other cargo. The user attaches the storage tote lifting device to a ladder and attaches the device's lifting handles to a tote, box, or other cargo. The user can then pull down on the device's top handle to raise the tote, box, or other cargo by pivoting the device around the ladder.

### FIELD OF THE INVENTION

The present invention relates generally to devices used for lifting. Particularly, the present invention is a device used to raise totes, boxes, or other cargo overhead for storage while using a ladder.

### BACKGROUND OF THE INVENTION

Raising totes, boxes, and other cargo for storage is dangerous. Commonly, many injuries may occur during heavy lifting, twisting of the spine, lifting from the ground, or lifting overhead. Further risk is introduced when using a ladder, as a user may fall off balance or have improper lifting form while balancing on a ladder. As the lifted item increases in size, weight, and height to be lifted, the risk of injury proportionally increases. Twisting the body while lifting an object upwards frequently causes injury, commonly in the lower back, and should be especially avoided.

In addition to the risk of injury, climbing up and down a ladder can be tedious and may waste time when storing many items. In the common household setting, storing many items at the top of a high shelf or closet takes time. This inefficiency extends to other settings, such as a warehouse, where storing many items is commonplace and occurs frequently.

Different items require different capabilities to be lifted. Human arms can only reach so wide to have a secure grip on a large object. At some point, the cumbersome volume of an object may be too large and prevent an individual from being able to grasp it at all before attempting to lift it. Poor grip further compounds the risk of injury with the inability to safely lift an object at all.

An objective of the present invention is to provide the safe, efficient, and effective lifting of totes, boxes, or other cargo while using a ladder. The present invention allows users to safely lift totes, boxes, or other cargo without the twisting of backs or arms, preventing common injury. Totes, boxes, and other cargo can be stored deeply because the present invention lifts both upwards and forwards. This forward motion provides efficiency by eliminating the need to push an item farther back when storing. The present invention allows users to lift heavier and larger objects than would be feasible to lift while climbing a ladder. Another objective of the present invention is to provide a device that is compatible with any standard ladder. This compatibility extends the benefits of the present invention to users that do not have access to other lifting devices or machinery, such as forklifts. Because the present invention attaches to any standard ladder, users can utilize the present invention in smaller spaces that can accommodate a ladder.

### SUMMARY OF THE INVENTION

The present invention is a device used to raise totes, boxes, or other cargo overhead while using a ladder. The present invention comprises a top section, a pivot point brace, an attaching mechanism on said pivot point brace, a middle section, a main brace, a bottom left arm, a bottom right arm, and lifting handles. The present invention connects to any standard ladder through an attaching mechanism on the pivot point brace. This attaching mechanism allows the present invention to pivot around the ladder as a fulcrum during use. The lifting handles attach to a tote. By pulling down on the top handle, the present invention pivots around the pivot point brace and lifts the tote above the ladder. The present invention not only raises the tote upwards but also forwards. Different variations of the lifting handles can be attached to grasp boxes and other cargo securely. The present invention also includes telescoping tubing that can adjust the length and width of the various arm components. The adjustment of width of the main brace further allows the present invention to accommodate larger totes, boxes, or other cargo for use. The adjustment of length of the arms further allows the present invention to raise totes, boxes, or other cargo for higher and farther lifting. The angle between the top section and the middle section of the present invention can be adjusted with an adjustable pivot ratchet found on the pivot point brace. The adjustment of angle between the top section and the middle section allows the present invention to raise totes, boxes, or other cargo farther. For example, the present invention can be used to store a box deeply at the back of a high raised shelf. During use, the top handle can be secured to the ladder to lock the present invention in a vertical position for unloading.

### BRIEF DESCRIPTION OF THE DRAWINGS

FIG. 1 is a front right perspective view of a storage tote lifting device.

FIG. 2 is a front elevational view of a storage tote lifting device.

FIG. 3 is a rear elevational view of a storage tote lifting device.

FIG. 4 is a right elevational view of a storage tote lifting device.

FIG. 5 is a left elevational view of a storage tote lifting device.

FIG. 6 is a top plan view of a storage tote lifting device.

FIG. 7 is a bottom plan view of a storage tote lifting device.

### DETAILED DESCRIPTION OF THE INVENTION

All illustrations of the drawings are for the purpose of describing selected versions of the present invention and are not intended to limit the scope of the present invention.

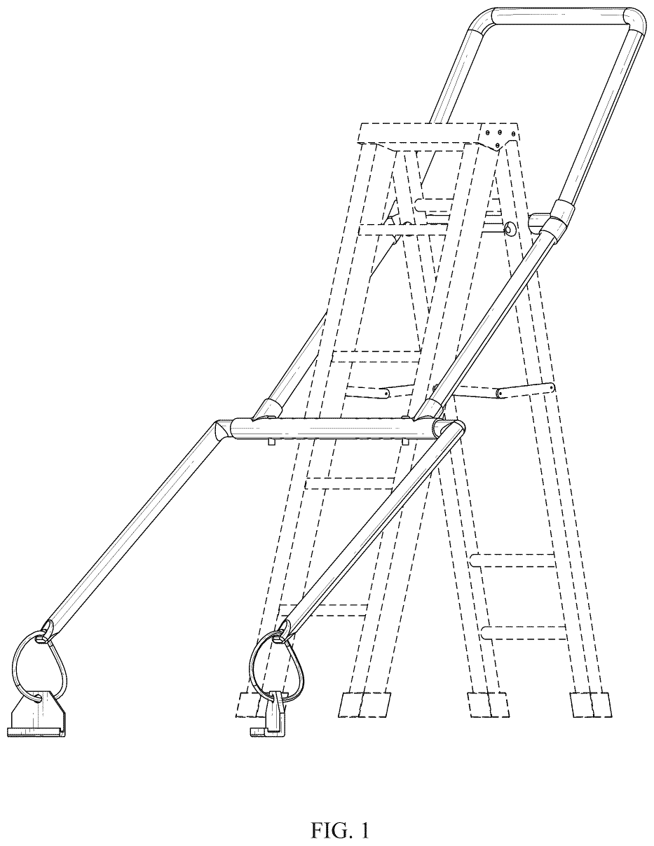

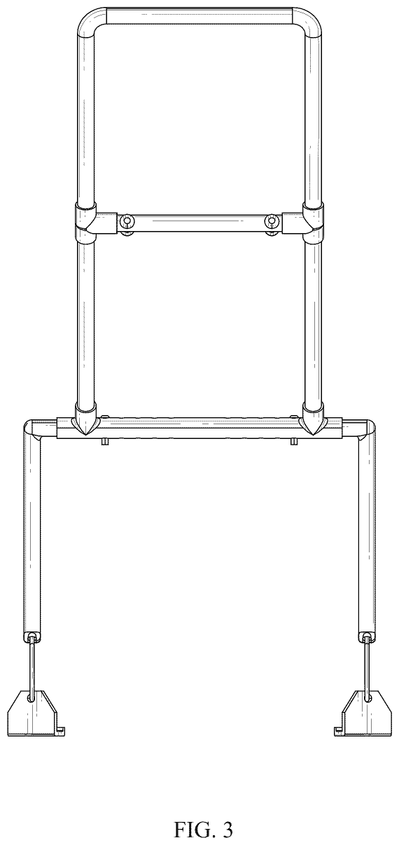

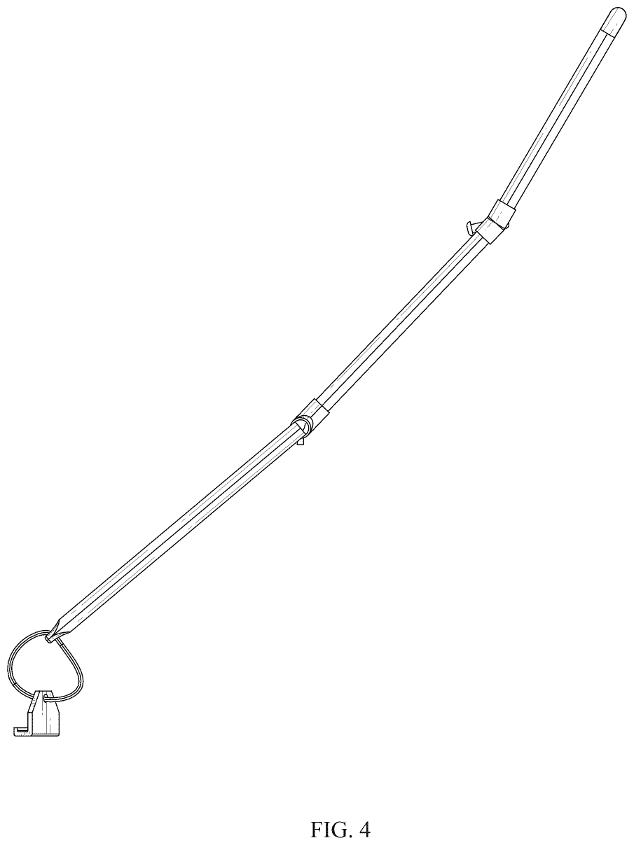

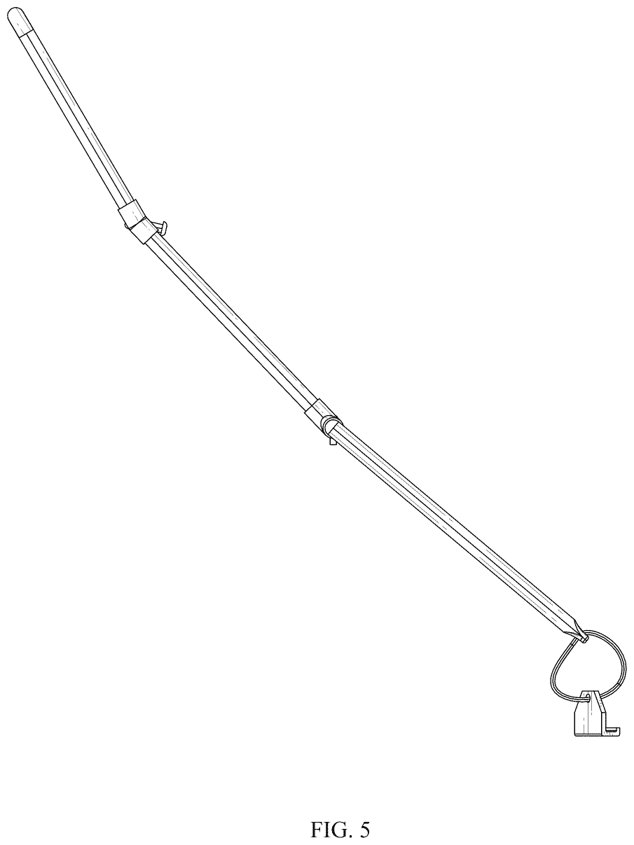

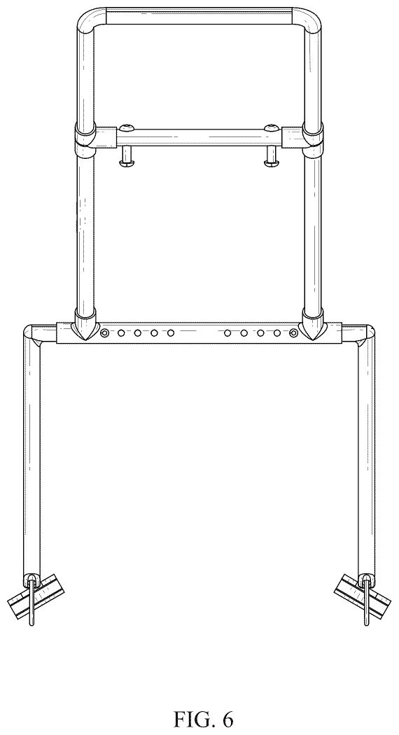

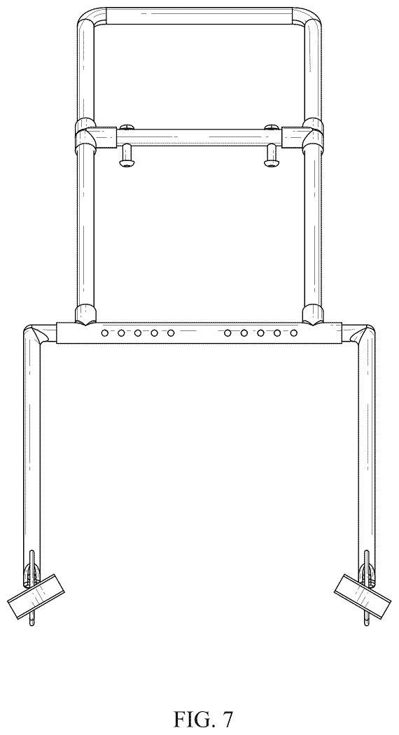

In reference to FIG. 1 through FIG. 7, the present invention is a storage tote lifting device.

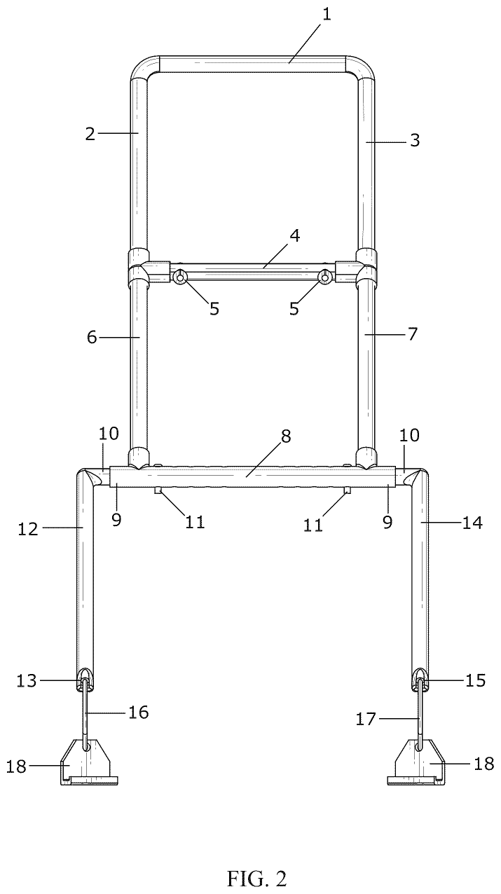

The following description is in reference to FIG. 2. The present invention comprises a top section, a pivot point brace 4, an attaching mechanism on said pivot point brace 5, a middle section, a main brace 8, a bottom left arm 12, a bottom right arm 14, and lifting handles 18.

The top section further comprises a top handle 1, a top left arm 2, and a top right arm 3. The top handle 1 horizontally connects to the top left arm 2 and to the top right arm 3. The top handle 1 may be bolted or welded to the top left arm 2 and to the top right arm 3. In the preferred embodiment of the present invention, the top handle 1 is 20″ long.

In the preferred embodiment of the present invention, the top handle 1 further comprises a locking mechanism. When the present invention is lifted during use, the locking mechanism on the top handle 1 secures the top handle 1 to a ladder to prevent the present invention from falling backwards. The locking mechanism on the top handle 1 may comprise a clamp that can be attached to the ladder without any modification to the ladder.

In the preferred embodiment of the present invention, the top left arm 2 and the top right arm 3 further comprise telescoping tubing with locking pins. The telescoping tubing allows for the adjustment of length of the top left arm 2 and the top right arm 3. The telescoping tubing comprises an outer sleeve of ¾″ diameter and inner tubing of ½″ diameter. The inner tubing slides within the outer sleeve. The telescoping tubing has holes for the locking pins. The locking pins of the telescoping tubing protrude through the holes to secure the length of the telescoping tubing. In the preferred embodiment of the present invention, the top left arm 2 and the top right arm 3 are 22″ long and can be extended by the telescoping tubing.

The pivot point brace 4 horizontally connects to the top left arm 2 and the top right arm 3. The pivot point brace 4 connects to any standard ladder using an attaching mechanism 5. In the preferred embodiment of the present invention, the attaching mechanism 5 comprises two drill holes and corresponding locking pins. These locking pins secure the present invention to the ladder and allows the present invention to pivot around the pivot point brace 4 as a fulcrum during use. In another embodiment of the present invention, the attaching mechanism 5 of the pivot point brace 4 comprises a clamp that attaches the present invention to any standard ladder. The clamp may allow the present invention to attach to a ladder without any modification to the ladder. In the preferred embodiment of the present invention, the pivot point brace 4 further comprises an adjustable pivot ratchet. This adjustable pivot ratchet can be manipulated to adjust the angle between the top section and the middle section. A smaller angle may allow the present invention to lift a tote or box farther horizontally during use.

The middle section further comprises a middle left arm 6 and a middle right arm 7. The middle left arm 6 and the middle right arm 7 connect to the pivot point brace 4. The middle left arm 6 and the middle right arm 7 may be bolted or welded to the pivot point brace 4. The middle left arm 6 and the middle right arm 7 connect to the main brace 8. The middle left arm 6 and the middle right arm 7 may be bolted or welded to the main brace 8. In the preferred embodiment of the present invention, the middle left arm 6 and the middle right arm 7 are 28″ long.

In another embodiment of the present invention, the top left arm 2 and the middle left arm 6 are one component bent at an angle. In another embodiment of the present invention, the top right arm 3 and the middle right arm 7 are one component bent at an angle.

The main brace 8 connects with the middle left arm 6, the middle right arm 7, the bottom left arm 12, and the bottom right arm 14. In another embodiment of the present invention, the main brace 8 further comprises an adjustable pivot ratchet. This adjustable pivot ratchet can be manipulated to adjust the angle between the middle section and the bottom left arm 12 and bottom right arm 14. In the preferred embodiment of the present invention, the main brace 8 further comprises telescoping tubing with locking pins 11. The telescoping tubing allows for the adjustment of width between the bottom left arm 12 and the bottom right arm 14. The telescoping tubing comprises an outer sleeve 9 of ¾″ diameter and inner tubing 10 of ½″ diameter. The inner tubing 10 slides within the outer sleeve 9. The telescoping tubing has holes for the locking pins 11. The locking pins 11 of the telescoping tubing protrude through the holes to secure the width of the telescoping tubing. In the preferred embodiment of the present invention, the main brace 8 is 30″ long and can be extended by the telescoping tubing.

The bottom left arm 12 connects with the main brace 8 and a lifting handle 18. In the preferred embodiment of the present invention, the bottom left arm 12 is 30″ long. In the preferred embodiment of the present invention, the bottom left arm 12 further comprises a hole 13 for carabiner, cables, hooks, or handles to connect to a lifting handle 18. This hole 13 allows the bottom left arm 12 to connect with a plurality of lifting handle 18 variations. In another embodiment of the present invention, the bottom left arm 12 further comprises of a measurement scale. This scale allows the user to know the height of the tote, box, or other cargo when the present invention is fully extended.

The bottom right arm 14 connects with the main brace 8 and a lifting handle 18. In the preferred embodiment of the present invention, the bottom right arm 14 is 30″ long. In the preferred embodiment of the present invention, the bottom right arm 14 further comprises a hole 15 for carabiner, cables, hooks, or handles to connect to a lifting handle 18. This hole 15 allows the bottom right arm 14 to connect with a plurality of lifting handle 18 variations. In another embodiment of the present invention, the bottom right arm 14 further comprises of a measurement scale. This scale allows the user to know the height of the tote, box, or other cargo when the present invention is fully extended.

The lifting handles 18 connect with the bottom left arm 12 and the bottom right arm 14. A plurality of lifting handle 18 variations exist. In the preferred embodiment of the present invention, the lifting handles 18 are designed to attach with a storage tote to lift said storage tote securely. In another embodiment of the present invention, the lifting handles are designed to attach beneath a box and comprise a spring or bungee cord that connects the lifting handles to each other. The spring or bungee cord squeeze the lifting handles together when lifting a box to prevent the box from shifting position. In another embodiment of the present invention, the lifting handles are designed to support a material tray or platform. Each variation of lifting handles 18 may be used to lift objects of different sizes and weight during use of the present invention as needed.

A preferred method of using the present invention comprises the following steps. The present invention is attached to any standard ladder by connecting the ladder with the attaching mechanism 5 found on the pivot point brace 4. The appropriate lifting handles 18 are attached to the tote, box, or other cargo that is intended to be lifted. The user will pull downwards on the top handle 1, lifting the tote, box, or other cargo while inverting the present invention and rotating around the pivot point brace 4. When the top handle 1 is fully pulled downwards, the top handle 1 may be secured to the ladder by the locking mechanism found on the top handle. The user may then climb the ladder and unload the tote, box, or other cargo from the lifting handles 18. After descending from the ladder, the user may repeat these steps to lift more items. The user is recommended to match the appropriate lifting handles 18 with the tote, box, or other cargo for the safest and most secure use of the present invention.

Although the invention has been explained in relation to its preferred embodiment, it is to be understood that many other possible modifications and variations can be made without departing from the spirit and scope of the invention as hereinafter claimed.

What is claimed is:

1. A storage tote lifting device, comprising:
a top section,
a pivot point brace,
an attaching mechanism on said pivot point brace,
a middle section,
a main brace,
a bottom left arm,
a bottom right arm, and
lifting handles.

2. The storage tote lifting device of claim 1, the top section further comprising:
a top handle,
a top left arm, and
a top right arm.

3. The storage tote lifting device of claim 2, the top handle further comprising a locking mechanism.

4. The storage tote lifting device of claim 3, wherein the locking mechanism comprises at least one clamp.

5. The storage tote lifting device of claim 2, the top section further comprising:
an outer sleeve of the top left arm,
inner tubing of the top left arm,
an outer sleeve of the top right arm,
inner tubing of the top right arm, and
locking pins.

6. The storage tote lifting device of claim 1, wherein the attaching mechanism comprises at least two drill holes and locking pins.

7. The storage tote lifting device of claim 1, wherein the attaching mechanism comprises at least one clamp.

8. The storage tote lifting device of claim 1, the pivot point brace further comprising an adjustable pivot ratchet mechanism.

9. The storage tote lifting device of claim 1, the middle section further comprising:
a middle left arm, and
a middle right arm.

10. The storage tote lifting device of claim 1, the main brace further comprising an adjustable pivot ratchet.

11. The storage tote lifting device of claim 1, the main brace further comprising:
an outer sleeve of the main brace,
inner tubing of the main brace, and
locking pins.

12. The storage tote lifting device of claim 1, further comprising:
a hole found on the bottom left arm,
a connecting mechanism attaching the bottom left arm with a lifting handle,
a hole found on the bottom right arm, and
a connecting mechanism attaching the bottom right arm with a lifting handle.

13. The storage tote lifting device of claim 1, wherein the lifting handles are shaped specifically for lifting totes.

14. The storage tote lifting device of claim 1, wherein the lifting handles are shaped specifically for lifting boxes and further comprise a spring.

15. The storage tote lifting device of claim 1, wherein the lifting handles are shaped specifically for lifting boxes and further comprise a bungee cord.

16. The storage tote lifting device of claim 1, wherein the lifting handles further comprise a tray platform.

17. A storage tote lifting device, comprising:
a top handle,
a top left arm,
a top right arm,
a pivot point brace,
an attaching mechanism on said pivot point brace,
a middle left arm,
a middle right arm,
a main brace,
a bottom left arm,
a bottom right arm, and
lifting handles.

18. The storage tote lifting device of claim 17, wherein the attaching mechanism comprises at least two drill holes and locking pins.

19. A storage tote lifting device, comprising:
a top handle,
a locking mechanism on said top handle,
a top right arm with an outer sleeve, inner tubing, and locking pins,
a top left arm with an outer sleeve, inner tubing, and locking pins,
a pivot point brace,
an attaching mechanism on said pivot point brace,
an adjustable pivot ratchet on said pivot point brace,
a middle left arm,
a middle right arm,
a main brace with an outer sleeve, inner tubing, and locking pins,
an adjustable ratchet on said main brace,
a bottom left arm,
a bottom right arm, and
lifting handles.

20. The storage tote lifting device of claim 19, wherein the attaching mechanism comprises at least two drill holes and locking pins.
